(19) United States
(12) Patent Application Publication
(10) Pub. No.: US 2021/0406155 A1
(43) Pub. Date: Dec. 30, 2021

(54) METHODS FOR CONFIGURING DEVICE DEBUGGING ENVIRONMENT AND CONFIGURATION SERVER

(71) Applicant: BAIDU ONLINE NETWORK TECHNOLOGY (BEIJING) CO., LTD., Beijing (CN)

(72) Inventors: Jiachuan JIAO, Beijing (CN); Hongwei CAO, Beijing (CN); Zhentao CHEN, Beijing (CN); Peng WANG, Beijing (CN)

(21) Appl. No.: 17/127,869

(22) Filed: Dec. 18, 2020

(30) Foreign Application Priority Data
Jun. 28, 2020 (CN) 202010599471.4

(51) Int. Cl. G06F 11/36

(52) U.S. Cl. CPC G06F 11/3664; G06F 11/3648

(57) ABSTRACT

Embodiments of the present disclosure disclose methods for configuring device debugging environment and a configuration server. The specific implementation is: obtaining a test device identifier; sending a configuration confirming message to a test device corresponding to the test device identifier, such that the test device, in response to a confirming operation on the configuration confirming message of a developer, sends a request message of a debugging environment adapted to the test device to a configuration server; and in response to the request message, sending the debugging environment to the test device for configuration by the test device.

### CROSS REFERENCE TO RELATED APPLICATION

This application is based on and claims priority to Chinese patent application No. 202010599471.4, filed on Jun. 28, 2020, the entire content of which is hereby incorporated into this application by reference.

### FIELD

The present disclosure relates to computer technologies, and more particularly, to the field of remote interaction and test technologies.

### BACKGROUND

When a certain device is tested, it is necessary to provide a debugging environment adapted to the device to complete tests before releasing the device for online use.

Generally, in order to ensure the safety of the device, a supplier delivers a device equipped with an adapted debugging environment to a tester for the tester to carry out tests. However, offline delivery increases cost of the supplier and prolongs a test cycle of the tester.

### SUMMARY

In a first aspect, embodiments of the present disclosure provide a method for configuring a device debugging environment. The method is applicable to a configuration server. The method includes: obtaining a test device identifier; sending a configuration confirming message to a test device corresponding to the test device identifier, such that the test device, in response to a confirming operation of a developer on the configuration confirming message, sends a request message of a debugging environment adapted to the test device to the configuration server; and in response to the request message, sending the debugging environment to the test device for configuration by the test device.

In a second aspect, embodiments of the present disclosure provide a method for configuring a device debugging environment. The method is applicable to a test device. The method includes: receiving a configuration confirming message sent by a configuration server; in response to a confirming operation of a developer on the configuration confirming message, sending a request message of a debugging environment adapted to the test device to the configuration server, such that the configured sever sends the debugging environment to the test device in response to the request message; and receiving the debugging environment returned by the configuration server, and configuring the debugging environment.

In a third aspect, embodiments of the present disclosure provide a configuration server. The configuration server includes at least one processor and a storage device communicatively connected to the at least one processor. The storage device stores an instruction executable by the at least one processor. When the instruction is executed by the at least one processor, the at least one processor may implement a method for configuring the device debugging environment. The method includes: obtaining a test device identifier; sending a configuration confirming message to a test device corresponding to the test device identifier, such that the test device, in response to a confirming operation of a developer on the configuration confirming message, sends a request message of a debugging environment adapted to the test device to the configuration server; and in response to the request message, sending the debugging environment to the test device for configuration by the test device.

It should be understood that the content described in the Summary is not intended to identify key or important features of embodiments of the present disclosure, nor is it intended to limit the scope of the present disclosure. Other features of the present disclosure will become easily understood through the following description.

### BRIEF DESCRIPTION OF THE DRAWINGS

The accompany drawings are used for a better understanding of the solution, and do not constitute a limitation to the present disclosure.

FIG. 1a is a schematic diagram of a configuration system for a device debugging environment according to embodiments of the present disclosure.

FIG. 1b is a flowchart of a method for configuring a device debugging environment according to embodiments of the present disclosure.

FIG. 2a is a schematic diagram of a configuration system for a device debugging environment according to embodiments of the present disclosure.

FIG. 2b is a flowchart of a method for configuring a device debugging environment according to embodiments of the present disclosure.

FIG. 3a is a schematic diagram of a configuration system for a device debugging environment according to embodiments of the present disclosure.

FIG. 3b is a flowchart of a method for configuring a device debugging environment according to embodiments of the present disclosure.

FIG. 4a is a schematic diagram of a configuration system for a device debugging environment according to embodiments of the present disclosure.

FIG. 4b is a flowchart of a method for configuring a device debugging environment according to embodiments of the present disclosure.

FIG. 5 is a flowchart of a method for configuring a device debugging environment according to embodiments of the present disclosure.

FIG. 6 is a schematic diagram of an apparatus for configuring a device debugging environment according to embodiments of the present disclosure.

FIG. 7 is a schematic diagram of an apparatus for configuring a device debugging environment according to embodiments of the present disclosure.

FIG. 8 is a schematic diagram of a configuration server according to embodiments of the present disclosure.

### DETAILED DESCRIPTION

Exemplary embodiments of the present disclosure are described below with reference to the accompanying drawings, which include various details of the embodiments of the present disclosure to facilitate understanding, and should be considered as merely exemplary.

Therefore, those skilled in the art should recognize that various changes and modifications may be made to the embodiments described herein without departing from the scope and spirit of the present disclosure. Also, for clarity and conciseness, descriptions of well-known functions and structures are omitted in the following description.

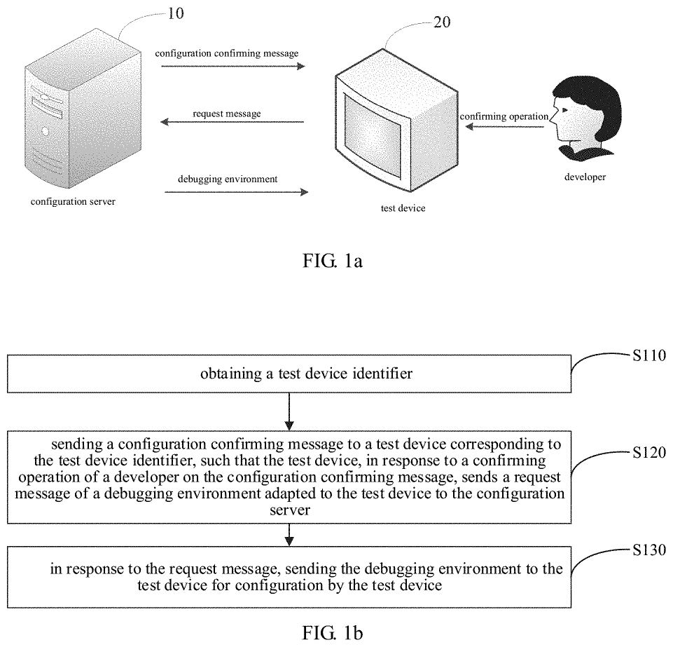

In order to clearly introduce embodiments of the present disclosure, the system to which a method for configuring a device debugging environment according to embodiments of the present disclosure is applicable is briefly introduced first. FIG. 1a is a schematic diagram of a configuration system for a device debugging environment according to embodiments of the present disclosure. As illustrated in FIG. 1a, the system includes a configuration server 10 and a test device 20.

A number of the test device 20 is at least one. The debugging environment may be configured for the test device 20 to complete tests before releasing the test device 20 for online use. Optionally, the test device 20 may be an intelligent voice device. Embedded software may be implanted on the intelligent voice device, such that functions may be realized by running the embedded software in cooperation with the web (World Wide Web, a global wide area network) service on the network side. On the basis, when performing a functional test, the intelligent voice device is configured with the debugging environment matching the intelligent voice device to complete the functional test.

The configuration server may be a single server or a cluster composed of multiple servers, and may be configured in the cloud. The configuration server stores debugging environments adapted to multiple test devices 20 respectively, and provides an adapted debugging environment to each test device 20 through remote interaction with each test device 20.

FIG. 1b is a flowchart of a method for configuring a device debugging environment according to embodiments of the present disclosure. Embodiments of the present disclosure are suitable for a case of providing the debugging environment adapted to the test device. The method is executed by an apparatus for configuring a device debugging environment. The apparatus is implemented by software and/or hardware, and is configured in the configuration server with certain data computing capabilities.

The method for configuring the device debugging environment as illustrated in FIG. 1b includes the following.

At block S110, a test device identifier is obtained.

The test device identifier is used to uniquely represent a test device, such as a model number and a serial number (SN) of the test device. The test device according to embodiments of the present disclosure does not require a developer to configure the debugging environment in advance, and nor does it require a developer to deliver, such that purchase channels and delivery channels may be widened, and cost of delivering the device is saved for the developer.

The present disclosure does not limit the source of the test device identifier, which may be from local storage space or external input. Optionally, the configuration server pre-stores a test device identifier of at least one test device, and selects one test device identifier therefrom.

At block S120, a configuration confirming message is sent to a test device corresponding to the test device identifier, such that the test device, in response to a confirming operation of a developer on the configuration confirming message, sends a request message of a debugging environment adapted to the test device to the configuration server.

The configuration server pre-stores a network address of the test device. After determining the test device, the configuration server sends the configuration confirming message based on the network address of the test device. The configuration confirming message is used to confirm the test device, that is, to confirm that a device that is to be configured with the debugging environment is the test device, rather than other test devices.

After receiving the configuration confirming message, the test device displays the configuration confirming message. For example, if the test device is provided with a display screen, the configuration confirming message will be displayed on the display screen to notify the developer.

When the test device displays the configuration confirming message, it means that the configuration server has performed a preliminary confirmation on the test device through the test device identifier, and the developer may perform a secondary confirmation on the test device. The developer triggers the confirming operation on the configuration confirming message on the test device. Exemplarily, the configuration confirming message is a configuration confirming message of the test device, such as “whether to configure the debugging environment of this test device”. The confirming operation is a trigger operation on a control or a button that means “yes”, such that the secondary confirmation of the test device is performed.

In response to the confirming operation of the developer on the configuration confirming message, the test device sends the request message of the debugging environment adapted to the test device to the configuration server when the test device locally has sufficient capacity to determine that the second confirmation is passed. The request message is used to request the configuration server to directly distribute the debugging environment. When the test device locally does not have sufficient capacity to determine whether the second confirmation is passed, the request message sent to the configuration server should also include the confirming operation, so that the configuration server may determine whether the second confirmation is passed.

At block S130, in response to the request message, the debugging environment is sent to the test device for configuration by the test device.

According to the above description, in some embodiments, when the request message is used to request the configuration server to directly distribute the debugging environment, the debugging environment adapted to the test device is directly sent to the test device. When the request message includes the confirming operation, the debugging environment is sent to the test device after determining that the secondary confirmation is passed on the basis of the confirming operation. When the test device or the configuration server determines that the secondary confirmation is not passed, the configuration operation of the debugging environment is cancelled.

In consideration of the remote communication between the configuration server and the test device, the configuration server sends the debugging environment to the test device through over the air (OTA).

In some embodiments, the debugging environment may include a complete installation package or an upgrade package of the debugging environment. When the test device has been configured with a debugging environment, the upgrade package may be sent to the test device, such that the test device runs the upgrade package to upgrade an original debugging environment. When the test device has not been configured with the debugging environment, the complete installation package may be sent to the test device, such that the test device runs the complete installation package to configure the debugging environment for the first time.

In embodiments of the present disclosure, the configuration server distributes the debugging environment through remote interaction with the test device, and thus the online dynamic configuration of the debugging environment may be performed in a simple and efficient manner. At the same time, the cost of the developer is saved as the developer does not need to deliver the device configured with the debugging environment. Through the test device identifier and the confirming operation of the developer on the configuration confirming message, the test device is confirmed twice, which improves the safety of the test device and avoids configuring an unrelated test device. During the entire test process, the developer needs to perform the confirming operation on the configuration confirming message to trigger the distribution of the debugging environment, so that participation of other service personnel is unnecessary, thereby realizing self-service of the whole process, saving time and cost, and shortening the test cycle.

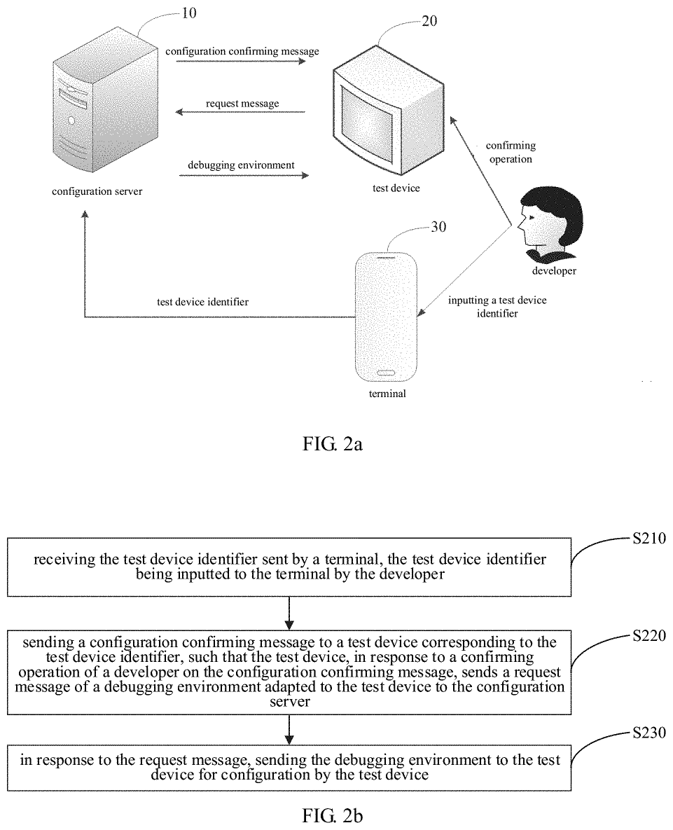

FIG. 2a is a schematic diagram of a configuration system for a device debugging environment according to embodiments of the present disclosure. On the basis of FIG. 1a, FIG. 2a also includes a terminal 30. The terminal 30 may be a smart phone, a desktop computer, a smart watch, and so on. The terminal 30 may log in to an open platform provided by the configuration server to interact with the configuration server.

FIG. 2b is a flowchart of a method for configuring a device debugging environment according to embodiments of the present disclosure. Embodiments of the present disclosure further optimize the process of obtaining the test device identifier on the basis of technical solutions of the foregoing embodiments. With reference to FIG. 2a, the method of configuring the device debugging environment illustrated in FIG. 2b includes the following.

At block S210, the test device identifier sent by a terminal is received. The test device identifier is inputted to the terminal by the developer.

When the developer needs to configure the debugging environment of a certain test device, the developer inputs the test device identifier of the test device into the terminal. In detail, the developer provides developer information (such as ID number or name, etc.) to register on the open platform. The registration includes individual registration and enterprise registration. In some embodiments, after the registration is completed, the test device identifier may be inputted on the open platform and bound with the developer information.

The developer performs the configuration confirming operation on the test device. For example, the developer enters the test device identifier on the open platform and clicks a configuration confirming option. In response to the configuration confirming operation of the developer on the test device, the terminal extracts the test device identifier inputted by the developer, and sends the test device identifier to the configuration server. Furthermore, the configuration server receives the test device identifier sent by the terminal.

At block S220, a configuration confirming message is sent to a test device corresponding to the test device identifier, such that the test device, in response to a confirming operation of a developer on the configuration confirming message, sends a request message of a debugging environment adapted to the test device to the configuration server.

At block S230, in response to the request message, the debugging environment is sent to the test device for configuration by the test device.

In embodiments of the present disclosure, the developer may send the test device identifier to the configuration server through the terminal, so as to actively initiate and determine the configuration operation of a certain test device. Consequently, initiative of the developer is improved.

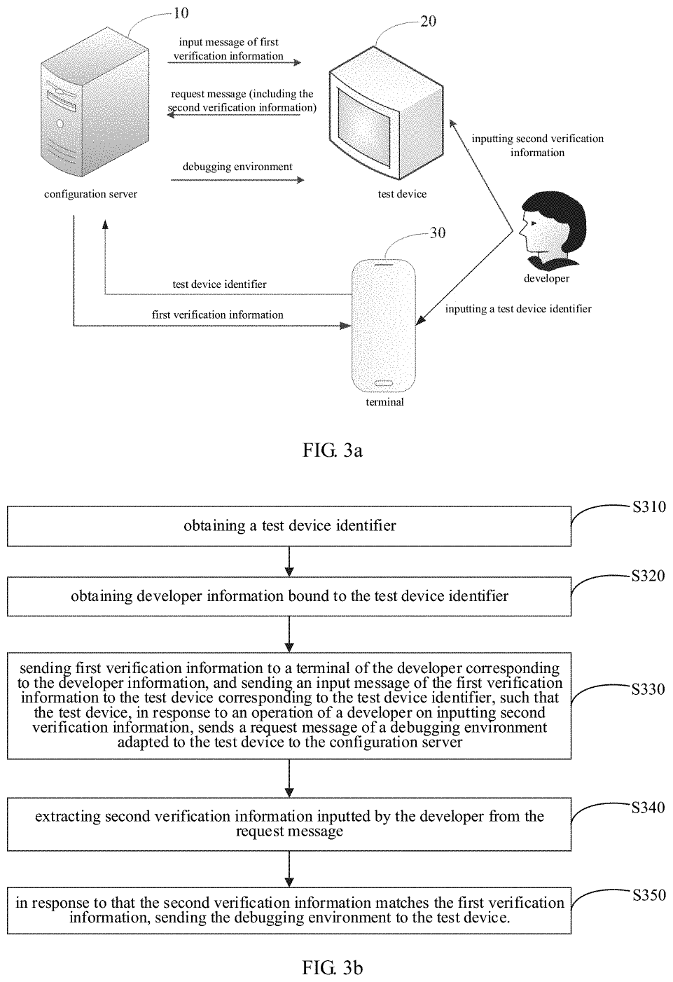

FIG. 3a is a schematic diagram of a configuration system for a device debugging environment according to embodiments of the present disclosure. The configuration system includes a configuration server 10, a test device 20 and a terminal 30. The specific structure of the configuration system may be referred to the description of the foregoing embodiments, and will not be repeated here.

FIG. 3b is a flowchart of a method for configuring a device debugging environment according to embodiments of the present disclosure. Embodiments of the present disclosure further optimize the process of sending the configuration confirming message on the basis of the technical solutions of the foregoing embodiments. With reference to FIG. 3a, the method for configuring the device debugging environment as illustrated in FIG. 3b includes the following.

At block S310, a test device identifier is obtained.

In some embodiments, the test device identifier sent by the terminal is received. The test device identifier is inputted to the terminal by the developer.

At block S320, developer information bound to the test device identifier is obtained.

At block S330, first verification information is sent to the developer corresponding to the developer information, and an input message of the first verification information is sent to the test device corresponding to the test device identifier, such that the test device, in response to an operation of inputting second verification information of the developer, sends a request message of the debugging environment adapted to the test device to the configuration server.

Sending the first verification information to the developer means sending the first verification information to the terminal. In some embodiments, in one case, the network address of the terminal held by the developer corresponding to the developer information is pre-stored, and the first verification information is sent based on the network address of the terminal. In another case, the test device identifier is received from the terminal, and thus the first verification information may be directly returned to the terminal. In some embodiments, the first verification information may be a random code, such as a series of numbers.

For the convenience of description and distinction, verification information sent by the configuration server is called the first verification information, and verification information entered by the developer into the test device is called the second verification information. It should be noted that a sending order of the first verification information and input information of the first verification information is not limited. The first verification information may be sent before the input information of the first verification information; or the input information of the first verification information may be sent before the first verification information; or the first verification information and the input information of the first verification information may be sent in parallel.

After receiving the first verification information, the terminal displays the first verification information on the screen of the terminal to notify the developer. After the test device receives an input message of the first verification information, an input box of the first verification information is displayed on the screen of the test device for the developer to input. If the test device identifier is correct, the developer will successfully receive the first verification information, and thus the input is correct. If the test device identifier is incorrect, the developer will not receive the first verification information, and thus the input is incorrect.

In response to an operation of inputting the second verification information of the developer, the test device sends the request message including the second verification information to the configuration server.

At block S340, second verification information inputted by the developer is extracted from the request message.

At block S350, in response to that the second verification information matches the first verification information, the debugging environment is sent to the test device.

When the configuration server determines that the second verification information matches the first verification information, for example, the first verification information is identical to the second verification information, and the second confirmation is passed, the debugging environment is sent to the test device. When the configuration server determines that the second verification information does not match the first verification information, and the second confirmation fails, the configuration operation of the debugging environment is cancelled.

In embodiments of the present disclosure, a binding relationship between the test device identifier and the developer information is stored in the configuration server. The configuration server determines whether the verification information matches. Double confirmation is performed on both of the developer and the test device, such that the safety of the test device may be fully ensured.

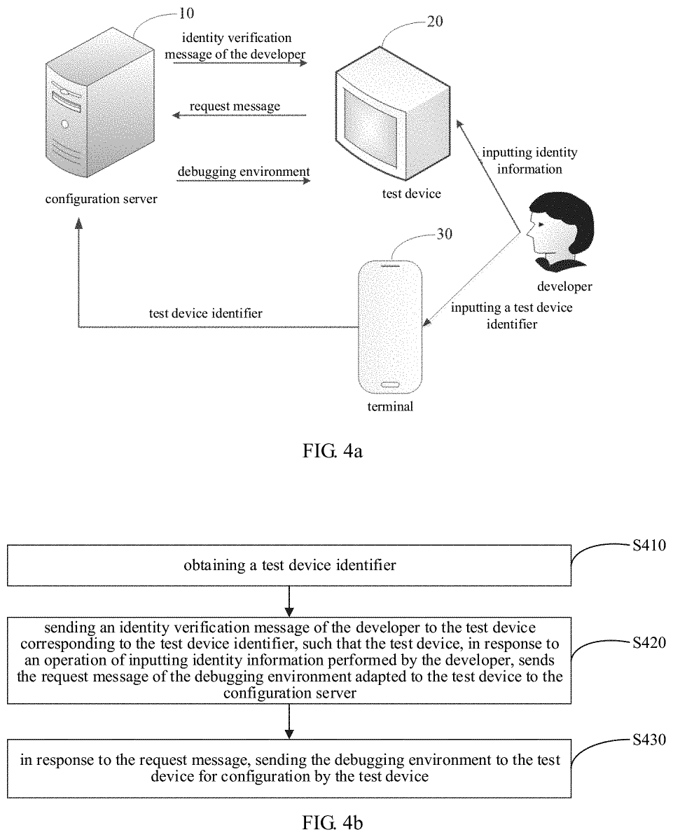

FIG. 4a is a schematic diagram of a configuration system for a device debugging environment according to embodiments of the present disclosure. The configuration system includes the configuration server 10, the test device 20 and the terminal 30. The specific structure of the configuration system may be referred to the description of the foregoing embodiments, and will not be repeated here.

FIG. 4b is a flowchart of a method for configuring a device debugging environment according to embodiments of the present disclosure. Embodiments of the present disclosure further optimize the process of sending the configuration confirming message on the basis of the technical solutions of the foregoing embodiments. With reference to FIG. 4a, the method for configuring the device debugging environment as illustrated in FIG. 4b includes the following.

At block S410, a test device identifier is obtained.

In some embodiments, the test device identifier sent by the terminal is received. The test device identifier is inputted to the terminal by the developer.

At block S420, an identity verification message of the developer is sent to the test device corresponding to the test device identifier, such that the test device, in response to an operation of inputting identity information performed by the developer, sends the request message of the debugging environment adapted to the test device to the configuration server.

The developer inputs the developer information on the test device in advance, and then the test device establishes the binding relationship between the developer information and the test device identifier. The identity verification message of the developer is, for example, “please enter developer information bound to this device”.

After the identity verification message is received by the test device, an input box of the identity verification message is displayed on the screen of the test device to prompt the developer to input identity information. When the test device identifier is correct, the test device will successfully receive the identity verification message. At the same time, when the developer and the test device have the binding relationship, the correct developer information will be inputted. When the test device identifier is incorrect, the test device will not receive the identity verification message. Or, even if the test device successfully receives the identity verification message, because of the developer being not the developer bound to the test device, the correct developer information will not be inputted.

In response to the operation of inputting the identity information performed by the developer, the test device obtains the developer information bound to the test device identifier, and locally determines whether the identity information inputted by the developer matches the developer information. When the identity information inputted by the developer matches the developer information, the request message of the debugging environment adapted to the test device is sent to the configuration server. When the identity information inputted by the developer does not match the developer information, the configuration operation of the debugging environment is cancelled.

At block S430, in response to the request message, the debugging environment is sent to the test device for configuration by the test device.

Since the test device has determined that the second confirmation is passed, the configuration server may directly send the debugging environment to the test device.

In embodiments of the present disclosure, the binding relationship between the test device identifier and the developer information is stored in the test device. The test device determines whether the identity information matches the developer information. Double confirmation is performed on both of the developer and the test device, such that the safety of the test device may be fully ensured.

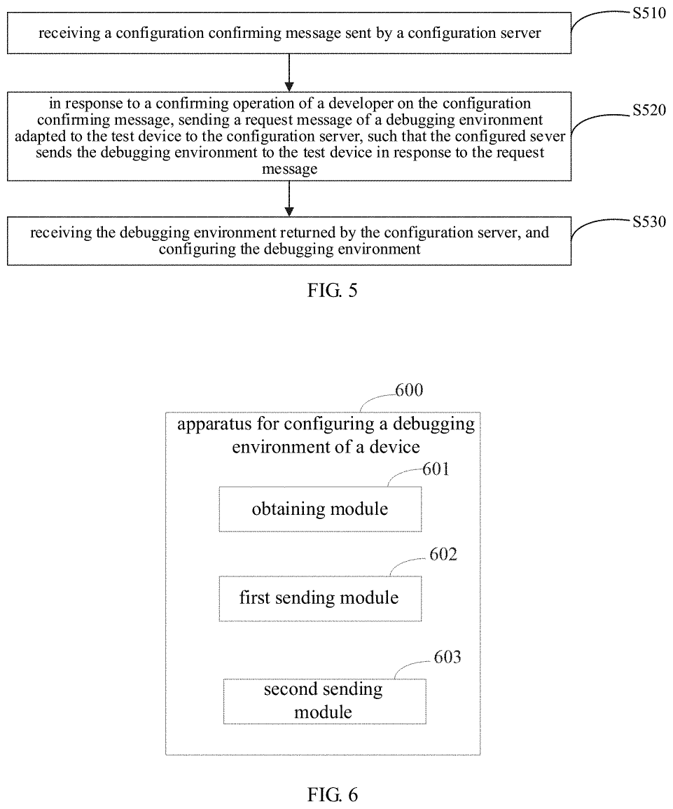

FIG. 5 is a flowchart of a method for configuring a device debugging environment according to embodiments of the present disclosure. Embodiments of the present disclosure are suitable for a case where the debugging environment is requested from the configuration server. The method is executed by an apparatus for configuring a device debugging environment. The apparatus is implemented by software and/or hardware, and is configured in the test device with certain data computing capabilities.

The method for configuring the device debugging environment illustrated in FIG. 5 includes the following.

At block S510, a configuration confirming message sent by a configuration server is received.

At block S520, in response to a confirming operation of a developer on the configuration confirming message, a request message of a debugging environment adapted to the test device is sent to the configuration server, such that the configured sever sends the debugging environment to the test device in response to the request message.

At block S530, the debugging environment returned by the configuration server is received, and the debugging environment is configured.

In embodiments of the present disclosure, the configuration server distributes the debugging environment through remote interaction with the test device, and thus the online dynamic configuration of the debugging environment may be performed in a simple and efficient manner. At the same time, the cost of the developer is saved as the developer does not need to deliver the device configured with the debugging environment. Through the test device identifier and the confirming operation of the developer on the configuration confirming message, the test device is confirmed twice, which improves the safety of the test device and avoids configuring an unrelated test device. During the entire test process, the developer needs to perform the confirming operation on the configuration confirming message to trigger the distribution of the debugging environment, so that participation of other service personnel is unnecessary, thereby realizing self-service of the whole process, saving time and cost, and shortening the test cycle.

In some embodiments, the configuration confirming message includes an input message of first verification information. Correspondingly, in response to the confirming operation of the developer on the configuration confirming message, sending the request message of the debugging environment adapted to the test device to the configuration server includes, in response to an operation of inputting second verification information of the developer, sending the request message comprising the second verification information to the configuration server, such that the configuration server, in response to determining that the second verification information matches the first verification information, sends the debugging environment to the test device. The first verification information is sent by the configuration server to a terminal of the developer corresponding to developer information. The developer information has a binding relationship with a test device identifier.

In some embodiments, the configuration confirming message comprises an identity verification message of the developer. Correspondingly, in response to the confirming operation of the developer on the configuration confirming message, sending the request message of the debugging environment adapted to the test device to the configuration server includes: in response to an operation of inputting identity information performed by the developer, obtaining developer information bound to the test device identifier; and in response to that the identity information matches the developer information, sending the request message of the debugging environment adapted to the test device to the configuration server.

For technical details and effects of embodiments of the present disclosure that are not explicitly illustrated, reference may be made to the description of the above-mentioned embodiments and the following embodiments, and thus repeated description is omitted herein.

According to embodiments of the present disclosure, FIG. 6 is a schematic diagram of an apparatus for configuring a device debugging environment according to embodiments of the present disclosure. Embodiments of the present disclosure are suitable for a case of providing the debugging environment adapted to the test device. The apparatus is implemented by software and/or hardware, and is configured in the configuration server.

The apparatus 600 for configuring the device debugging environment illustrated in FIG. 6 includes an obtaining module 601, a first sending module 602 and a second sending module 603.

The obtaining module 601 is configured to obtain a test device identifier.

The first sending module 602 is configured to send a configuration confirming message to a test device corresponding to the test device identifier, such that the test device, in response to a confirming operation of a developer on the configuration confirming message, sends a request message of a debugging environment adapted to the test device to the configuration server.

The second sending module 603 is configured to, in response to the request message, send the debugging environment to the test device for configuration by the test device.

In embodiments of the present disclosure, the configuration server distributes the debugging environment through remote interaction with the test device, and thus the online dynamic configuration of the debugging environment may be performed in a simple and efficient manner. At the same time, the cost of the developer is saved as the developer does not need to deliver the device configured with the debugging environment. Through the test device identifier and the confirming operation of the developer on the configuration confirming message, the test device is confirmed twice, which improves the safety of the test device and avoids configuring an unrelated test device. During the entire test process, the developer needs to perform the confirming operation on the configuration confirming message to trigger the distribution of the debugging environment, so that the participation of other service personnel is unnecessary, thereby realizing self-service of the whole process, saving time and cost, and shortening the test cycle.

Further, the obtaining module 601 is configured to receive the test device identifier sent by a terminal. The test device identifier is inputted to the terminal by the developer.

Further, the first sending module 602 includes an obtaining unit, a first sending unit and a second sending unit. The obtaining unit is configured to obtain developer information bound to the test device identifier. The first sending unit is configured to send first verification information to a terminal of the developer corresponding to the developer information. The second sending unit is configured to send an input message of the first verification information to the test device corresponding to the test device identifier. Correspondingly, the second sending module 603 is configured to extract second verification information inputted by the developer from the request message, and in response to that the second verification information matches the first verification information, to send the debugging environment to the test device.

Further, the first sending module 602 is configured to send an identity verification message of the developer to the test device corresponding to the test device identifier. The test device identifier has a binding relationship with developer information.

The apparatus for configuring the device debugging environment described above may implement the method for configuring the device debugging environment according to any embodiment of the present disclosure, and has functional modules and beneficial effects corresponding to implementing the method for configuring the device debugging environment.

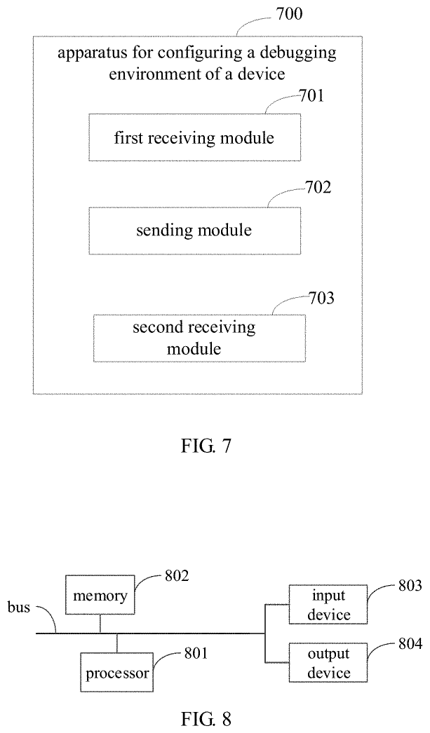

According to embodiments of the present disclosure, FIG. 7 is a schematic diagram of an apparatus for configuring a device debugging environment according to embodiments of the present disclosure. Embodiments of the present disclosure are suitable for a case where the debugging environment is requested from the configuration server. The apparatus is implemented by software and/or hardware, and is configured in the test device.

The apparatus 700 for configuring the device debugging environment illustrated in FIG. 7 includes a first receiving module 701, a sending module 702 and a second receiving module 703.

The first receiving module 701 is configured to receive a configuration confirming message sent by a configuration server.

The sending module 702 is configured to, in response to a confirming operation of a developer on the configuration confirming message, send a request message of a debugging environment adapted to the test device to the configuration server, such that the configured sever sends the debugging environment to the test device in response to the request message. The second receiving module 703 is configured to receive the debugging environment returned by the configuration server, and to configure the debugging environment.

In embodiments of the present disclosure, the configuration server distributes the debugging environment through remote interaction with the test device, and thus the online dynamic configuration of the debugging environment may be performed in a simple and efficient manner. At the same time, the cost of the developer is saved as the developer does not need to deliver the device configured with the debugging environment. Through the test device identifier and the confirming operation of the developer on the configuration confirming message, the test device is confirmed twice, which improves the safety of the test device and avoids configuring an unrelated test device. During the entire test process, the developer needs to perform the confirming operation on the configuration confirming message to trigger the distribution of the debugging environment, so that the participation of other service personnel is unnecessary, thereby realizing self-service of the whole process, saving time and cost, and shortening the test cycle.

Further, the configuration confirming message includes an input message of first verification information. The sending module 702 is configured to, in response to an operation of inputting second verification information of the developer, send the request message comprising the second verification information to the configuration server, such that the configuration server, in response to determining that the second verification information matches the first verification information, sends the debugging environment to the test device. The first verification information is sent by the configuration server to a terminal of the developer corresponding to developer information. The developer information has a binding relationship with a test device identifier.

Further, the configuration confirming message includes an identity verification message of the developer. The sending module 702 is configured to: in response to an operation of inputting identity information performed by the developer, obtain developer information bound to the test device identifier; and in response to that the identity information matches the developer information, send the request message of the debugging environment adapted to the test device to the configuration server.

The apparatus for configuring the device debugging environment described above may implement the method for configuring the device debugging environment according to any embodiment of the present disclosure, and has functional modules and beneficial effects corresponding to implementing the method for configuring the device debugging environment.

According to embodiments of the present disclosure, the preset disclosure also provides a configuration server, a test device and a readable storage medium.

FIG. 8 is a schematic diagram of a configuration server for implementing a method for configuring a device debugging environment according to embodiments of the present disclosure. The configuration server is intended to represent various forms of digital computers, such as a laptop computer, a desktop computer, a workbench, a personal digital assistant, a server, a blade server, a mainframe computer and other suitable computers. The configuration server may also represent various forms of mobile devices, such as a personal digital processor, a cellular phone, a smart phone, a wearable device and other similar computing devices. Components shown herein, their connections and relationships as well as their functions are merely examples, and are not intended to limit the implementation of the present disclosure described and/or required herein.

As illustrated in FIG. 8, the configuration server includes: one or more processors 801, a memory 802, and interfaces for connecting various components, including a high-speed interface and a low-speed interface. The components are interconnected by different buses and may be mounted on a common motherboard or otherwise installed as required. The processor may process instructions executed within the configuration server, including instructions stored in or on the memory to display graphical information of the GUI on an external input/output device (such as a display device coupled to the interface). In other embodiments, when necessary, multiple processors and/or multiple buses may be used with multiple memories. Similarly, multiple configuration servers may be connected, each providing some of the necessary operations (for example, as a server array, a group of blade servers, or a multiprocessor system). One processor 801 is taken as an example in FIG. 8.

The memory 802 is a non-transitory computer-readable storage medium according to the embodiments of the present disclosure. The memory stores instructions executable by at least one processor, so that the at least one processor executes the method for configuring the device debugging environment provided by the present disclosure. The non-transitory computer-readable storage medium according to the present disclosure stores computer instructions, which are configured to make the computer execute the method for configuring the device debugging environment provided by the present disclosure.

As a non-transitory computer-readable storage medium, the memory 802 may be configured to store non-transitory software programs, non-transitory computer executable programs and modules, such as program instructions/modules (for example, the obtaining module 601, the first sending module 602 and the second sending module 603 illustrated in FIG. 6) corresponding to the method for configuring the device debugging environment according to embodiments of the present disclosure. The processor 801 executes various functional applications and performs data processing of the server by running non-transitory software programs, instructions and modules stored in the memory 802, that is, the method for configuring the device debugging environment according to the foregoing method embodiments is implemented.

The memory 802 may include a storage program area and a storage data area, where the storage program area may store an operating system and applications required for at least one function; and the storage data area may store data created according to the use of the configuration server that implements the method for configuring the device debugging environment, and the like. In addition, the memory 802 may include a high-speed random-access memory, and may further include a non-transitory memory, such as at least one magnetic disk memory, a flash memory device, or other non-transitory solid-state memories. In some embodiments, the memory 802 may optionally include memories remotely disposed with respect to the processor 801, and these remote memories may be connected to the configuration server, which is configured to implement the method for configuring the device debugging environment, through a network. Examples of the network include, but are not limited to, the Internet, an intranet, a local area network, a mobile communication network, and combinations thereof.

The configuration server configured to implement the method for configuring the device debugging environment may further include an input device 803 and an output device 804.

The processor 801, the memory 802, the input device 803 and the output device 804 may be connected through a bus or in other manners. FIG. 8 is illustrated by establishing the connection through a bus.

The input device 803 may receive input numeric or character information, and generate key signal inputs related to user settings and function control of the configuration server configured to implement the method for configuring the device debugging environment, such as a touch screen, a keypad, a mouse, a trackpad, a touchpad, a pointing stick, one or more mouse buttons, trackballs, joysticks and other input devices. The output device 804 may include a display device, an auxiliary lighting device (for example, an LED), a haptic feedback device (for example, a vibration motor), and so on. The display device may include, but is not limited to, a liquid crystal display (LCD), a light emitting diode (LED) display and a plasma display. In some embodiments, the display device may be a touch screen.

The structure of the test device is illustrated in FIG. 8. The difference is that the memory 802, as a non-transitory computer-readable storage medium, may be used to store non-transitory software programs, non-transitory computer executable programs and modules, such as program instructions/modules (for example, the first receiving module 701, the sending module 702 and the second receiving module 703 illustrated in FIG. 7) corresponding to method for configuring the device debugging environment according to embodiments of the present disclosure. The processor 801 executes various functional applications and performs data processing of the server by running non-transitory software programs, instructions, and modules stored in the memory 802, that is, the method for configuring the device debugging environment according to the foregoing method embodiments is implemented.

Various implementations of systems and technologies described herein may be implemented in digital electronic circuit systems, integrated circuit systems, application-specific ASICs (application-specific integrated circuits), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device and the at least one output device.

These computing programs (also known as programs, software, software applications, or codes) include machine instructions of a programmable processor, and may implement these calculation procedures by utilizing high-level procedures and/or object-oriented programming languages, and/or assembly/machine languages. As used herein, terms “machine-readable medium” and “computer-readable medium” refer to any computer program product, device and/or apparatus configured to provide machine instructions and/or data to a programmable processor (for example, a magnetic disk, an optical disk, a memory and a programmable logic device (PLD)), and includes machine-readable media that receive machine instructions as machine-readable signals. The term “machine-readable signals” refers to any signal used to provide machine instructions and/or data to a programmable processor.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to provide interactions with the user; for example, the feedback provided to the user may be any form of sensory feedback (e.g., visual feedback, auditory feedback or haptic feedback); and input from the user may be received in any form (including acoustic input, voice input or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components or the front-end components. The components of the system may be interconnected by digital data communication (e.g., a communication network) in any form or medium. Examples of the communication network include: a local area network (LAN), a wide area network (WAN), the Internet, and the block-chain network.

Computer systems may include a client and a server. The client and server are generally remote from each other and typically interact through the communication network. A client-server relationship is generated by computer programs running on respective computers and having a client-server relationship with each other.

It should be understood that various forms of processes shown above may be reordered, added or deleted. For example, the blocks described in the present disclosure may be executed in parallel, sequentially, or in different orders. As long as the desired results of the technical solution disclosed in the present disclosure may be achieved, there is no limitation herein.

The foregoing specific implementations do not constitute a limit on the protection scope of the present disclosure. It should be understood by those skilled in the art that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for configuring a device debugging environment, applicable to a configuration server, and comprising:
obtaining a test device identifier;
sending a configuration confirming message to a test device corresponding to the test device identifier, such that the test device, in response to a confirming operation of a developer on the configuration confirming message, sends a request message of a debugging environment adapted to the test device to the configuration server; and
in response to the request message, sending the debugging environment to the test device for configuration by the test device.

2. The method of claim 1, wherein obtaining the test device identifier comprises:
receiving the test device identifier sent by a terminal, the test device identifier being inputted to the terminal by the developer.

3. The method of claim 1, wherein sending the configuration confirming message to the test device corresponding to the test device identifier comprises:
obtaining developer information bound to the test device identifier;
sending first verification information to a terminal of the developer corresponding to the developer information; and
sending an input message of the first verification information to the test device corresponding to the test device identifier; and
in response to the request message, sending the debugging environment to the test device comprises:
extracting second verification information inputted by the developer from the request message; and
in response to that the second verification information matches the first verification information, sending the debugging environment to the test device.

4. The method of claim 2, wherein sending the configuration confirming message to the test device corresponding to the test device identifier comprises:
obtaining developer information bound to the test device identifier;
sending first verification information to a terminal of the developer corresponding to the developer information; and
sending an input message of the first verification information to the test device corresponding to the test device identifier; and
in response to the request message, sending the debugging environment to the test device comprises:
extracting second verification information inputted by the developer from the request message; and
in response to that the second verification information matches the first verification information, sending the debugging environment to the test device.

5. The method of claim 1, wherein sending the configuration confirming message to the test device corresponding to the test device identifier comprises:
sending an identity verification message of the developer to the test device corresponding to the test device identifier;
wherein, the test device identifier has a binding relationship with developer information.

6. The method of claim 2, wherein sending the configuration confirming message to the test device corresponding to the test device identifier comprises:
sending an identity verification message of the developer to the test device corresponding to the test device identifier;
wherein, the test device identifier has a binding relationship with developer information.

7. The method of claim 1, wherein the debugging environment comprises a complete installation package or an upgrade package of the debugging environment,
sending the complete installation package to the test device, when determining that the test device has not been configured with the debugging environment;
sending the complete upgrade package to the test device, when determining that the test device has been configured with the debugging environment.

8. A method for configuring a device debugging environment, applicable to a test device, and comprising:
receiving a configuration confirming message sent by a configuration server;
in response to a confirming operation of a developer on the configuration confirming message, sending a request message of a debugging environment adapted to the test device to the configuration server, such that the configured sever sends the debugging environment to the test device in response to the request message; and
receiving the debugging environment returned by the configuration server, and configuring the debugging environment.

9. The method of claim 8, wherein the configuration confirming message comprises an input message of first verification information; and
in response to the confirming operation of the developer on the configuration confirming message, sending the request message of the debugging environment adapted to the test device to the configuration server comprises:
in response to an operation of inputting second verification information of the developer, sending the request message comprising the second verification information to the configuration server, such that the configuration server, in response to determining that the second verification information matches the first verification information, sends the debugging environment to the test device;
wherein, the first verification information is sent by the configuration server to a terminal of the developer corresponding to developer information, and the developer information has a binding relationship with a test device identifier.

10. The method of claim 8, wherein the configuration confirming message comprises an identity verification message of the developer; and
in response to the confirming operation of the developer on the configuration confirming message, sending the request message of the debugging environment adapted to the test device to the configuration server comprises:
in response to an operation of inputting identity information performed by the developer, obtaining developer information bound to the test device identifier; and
in response to that the identity information matches the developer information, sending the request message of the debugging environment adapted to the test device to the configuration server.

11. The method of claim 8, wherein the debugging environment comprises a complete installation package or an upgrade package of the debugging environment,
configuring the debugging environment for a first time, when receiving the complete installation package;
upgrading an original debugging environment, when receiving the upgrade package.

12. A configuration server, comprising:
at least one processor; and
a storage device communicatively connected to the at least one processor; wherein,
the storage device stores an instruction executable by the at least one processor, and when the instruction is executed by the at least one processor, the at least one processor may implement the method for configuring a device debugging environment, wherein the method comprises:
obtaining a test device identifier;
sending a configuration confirming message to a test device corresponding to the test device identifier, such that the test device, in response to a confirming operation of a developer on the configuration confirming message, sends a request message of a debugging environment adapted to the test device to the configuration server; and
in response to the request message, sending the debugging environment to the test device for configuration by the test device.

13. The configuration server of claim 12, wherein obtaining the test device identifier comprises:
receiving the test device identifier sent by a terminal, the test device identifier being inputted to the terminal by the developer.

14. The configuration server of claim 12, wherein sending the configuration confirming message to the test device corresponding to the test device identifier comprises:
obtaining developer information bound to the test device identifier;
sending first verification information to a terminal of the developer corresponding to the developer information; and
sending an input message of the first verification information to the test device corresponding to the test device identifier; and
in response to the request message, sending the debugging environment to the test device comprises:
extracting second verification information inputted by the developer from the request message; and
in response to that the second verification information matches the first verification information, sending the debugging environment to the test device.

15. The configuration server of claim 13, wherein sending the configuration confirming message to the test device corresponding to the test device identifier comprises:
obtaining developer information bound to the test device identifier;
sending first verification information to a terminal of the developer corresponding to the developer information; and
sending an input message of the first verification information to the test device corresponding to the test device identifier; and
in response to the request message, sending the debugging environment to the test device comprises:
extracting second verification information inputted by the developer from the request message; and
in response to that the second verification information matches the first verification information, sending the debugging environment to the test device.

16. The configuration server of claim 12, wherein sending the configuration confirming message to the test device corresponding to the test device identifier comprises:
sending an identity verification message of the developer to the test device corresponding to the test device identifier;
wherein, the test device identifier has a binding relationship with developer information.

17. The configuration server of claim 13, wherein sending the configuration confirming message to the test device corresponding to the test device identifier comprises:
sending an identity verification message of the developer to the test device corresponding to the test device identifier;
wherein, the test device identifier has a binding relationship with developer information.

18. The configuration server of claim 12, wherein the debugging environment comprises a complete installation package or an upgrade package of the debugging environment,
sending the complete installation package to the test device, when determining that the test device has not been configured with the debugging environment;
sending the complete upgrade package to the test device, when determining that the test device has been configured with the debugging environment.
